(19) United States
(12) Patent Application Publication
(10) Pub. No.: US 2017/0255361 A1
(43) Pub. Date: Sep. 7, 2017

(54) APPLICATION PROCESSING METHOD AND TERMINAL

(71) Applicant: ZTE CORPORATION, Shenzhen City (CN)

(72) Inventor: Xiaohong ZHAO, Shenzhen City (CN)

(73) Assignee: ZTE CORPORATION, Shenzhen City (CN)

(21) Appl. No.: 15/500,235

(22) PCT Filed: Sep. 15, 2014
(86) PCT No.: PCT/CN2014/086567

§ 371 Date: Jan. 30, 2017

(30) Foreign Application Priority Data
Jul. 29, 2014 (CN) 201410367500.9

(51) Int. Cl. G06F 3/0481; G06F 9/44; G06F 3/0484

(52) U.S. Cl. CPC G06F 3/04817; G06F 3/04845; G06F 9/4443

(57) ABSTRACT

The present disclosure discloses an Application (APP) processing method. The method includes that: when an external memory is in a mounted state and a movement instruction triggered by a user is received, APP icons of various preset APPs in an APP operation interface of a built-in memory are marked as being in a movable state; and when a movement operation performed by the user on an APP icon in the APP operation interface of the built-in memory is detected, the APP corresponding to the APP icon is moved from the built-in memory to the external memory. The present disclosure also discloses a terminal. An embodiment of the present disclosure brings convenience to the operation of the user and improves the efficiency of moving APP.

### CROSS-REFERENCE TO RELATED APPLICATIONS

This application is the U.S. national phase of PCT Application No. PCT/CN2014/086567 filed Sep. 15, 2014, which claims priority to Chinese Application No. 201410367500.9 filed Jul. 29, 2014, the disclosures of which are incorporated in their entirety by reference herein.

### TECHNICAL FIELD

The present disclosure relates to the field of terminals, and more particularly to an Application (APP) processing method and a terminal.

### BACKGROUND

When installing an APP in a terminal, a user may select to install the APP in a built-in memory or external memory of the terminal, so that the user may conveniently select an installing position of the APP according to a requirement. However, once the APP is installed in the built-in memory of the terminal, if the user is required to move the APP to the external memory, the user may execute a movement operation on the corresponding APP only by opening a corresponding APP management interface or APP management software at first, finding a corresponding function option in the APP management interface or the APP management software and opening the function option to enter an operation interface, which brings great inconvenience to the operation of the user and causes relatively lower efficiency.

The above content is only adopted to assist in understanding the technical solutions of the present disclosure, and it does not mean recognizing that the above content is an existing technology.

### SUMMARY

A main purpose of the present disclosure is to solve the technical problem that a corresponding APP may be moved to an external memory only by virtue of an APP management interface or APP management software.

In order to achieve the abovementioned purpose, the present disclosure provides an APP processing method, the APP processing method including the following steps.

When an external memory is in a mounted state and a movement instruction triggered by a user is received, APP icons of various preset APPs in an APP operation interface of a built-in memory are marked as being in a movable state.

When a movement operation performed by the user on an APP icon in the APP operation interface of the built-in memory is detected, the APP corresponding to the APP icon is moved from the built-in memory to the external memory.

Alternatively, the step w the external memory is determined to be in the mounted state includes that:

when the external memory is detected to be loaded and mounted in real time or regularly, APPs in the external memory are scanned; and

when the APPs are scanned in the external memory, an APP operation interface of the external memory is provided, and APP icons of various APPs in the external memory are displayed.

Alternatively, the step that the APP corresponding to the movement operation is moved from the built-in memory to the external memory when the movement operation performed by the user on the APP icon in the APP operation interface of the built-in memory is detected includes that:

when it is detected that the user moves the APP icon in the APP operation interface of the built-in memory to the APP operation interface of the external memory, the user is prompted whether to move the corresponding APP to the external memory or not; and

when the user confirms to move the corresponding APP to the external memory, the APP is moved from the built-in memory to the external memory and a movement progress is displayed.

Alternatively, before the step that the APP icons of various preset APPs in the APP operation interface of the built-memory are marked as being in the movable state when the movement instruction triggered by the user is received, the APP processing method includes that:

an edit control is provided for the user to trigger the movement instruction.

Alternatively, after the step that the APP operation interface of the external memory is provided and the APP icons of various APPs in the external memory are displayed, the method includes that:

when it is detected that the external memory is removed, the APP operation interface of the external memory is closed.

In addition, in order to achieve the abovementioned purpose, the present disclosure also provides a terminal. The terminal includes the following modules.

A marking module is arranged to, when an external memory is in a mounted state and a movement instruction triggered by a user is received, mark APP icons of various preset APPs in an APP operation interface of a built-in memory as being in a movable state; and

A movement module is arranged to, when a movement operation performed by the user on an APP icon in the APP operation interface of the built-in memory is detected, move the APP corresponding to the APP icon from the built-in memory to the external memory.

Alternatively, the marking module includes the following units.

A scanning unit is arranged to, when the external memory is detected to be loaded and mounted in real time or regularly, scan APPs in the external memory.

A display unit is arranged to, when the APPs are scanned in the external memory, provide an APP operation interface of the external memory, and display APP icons of various APPs in the external memory.

Alternatively, the movement module includes the following units.

A detection unit is arranged to, when it is detected that the user moves the APP icon in the APP operation interface of the built-in memory to the APP operation interface of the external memory, prompt the user whether to move the corresponding APP to the external memory or not; and

A movement unit is arranged to, when the user confirms to move the corresponding APP to the external memory, move the APP from the built-in memory to the external memory and display a movement progress.

Alternatively, the terminal includes the following module.

An edit control provision module is arranged to provide an edit control for the user to trigger the movement instruction.

Alternatively, the display unit is also arranged to, when it is detected that the external memory is removed, close the APP operation interface of the external memory.

According to the embodiment of the present disclosure, when the external memory is in the mounted state and the movement instruction triggered by the user is received, the APP icons of various preset APPs in the APP operation interface of the built-in memory are marked as being in the movable state. When the movement operation performed on the user on the APP icon in the APP operation interface of the built-in memory is detected, the APP corresponding to the APP icon is moved from the built-in memory to the external memory. By the embodiment of the present disclosure, the user may move the APP into the external memory only by operating the APP icon in the APP operation interface of the built-in memory. Therefore, the embodiment of the present disclosure brings convenience to the operation of the user and improves the efficiency of moving the APP.

### BRIEF DESCRIPTION OF DRAWINGS

FIG. 1 is a flowchart of a first embodiment of an APP processing method according to the present disclosure;

FIG. 2 is a flowchart of a second embodiment of an APP processing method according to the present disclosure;

FIG. 3 is a flowchart of a fourth embodiment of an APP processing method according to the present disclosure;

FIG. 4 is a schematic diagram of an APP operation interface of an external memory;

FIG. 5 is a schematic diagram of an APP icon marked as being in a movable state;

FIG. 6 is a schematic diagram of function modules of a first embodiment of a terminal according to the present disclosure;

FIG. 7 is a schematic diagram of function modules of a second embodiment of a terminal according to the present disclosure; and

FIG. 8 is a schematic diagram of function modules of a fourth embodiment of a terminal according to the present disclosure.

Achievement of the purpose, functional characteristics and advantages of the present disclosure will be further described with reference to embodiments and the drawings.

### SPECIFIC EMBODIMENTS

It should be understood that specific embodiments described here are merely adopted to explain the present disclosure and not intended to limit the present disclosure.

Those skilled in the art should understand that an implementation main body which implements an APP processing method of the present disclosure in the following embodiment of the APP processing method of the present disclosure may be a terminal such as a mobile phone, a tablet computer and a smart television, etc., and may also be any other terminal or device which may implement the APP processing method of the present disclosure, which will not be limited in the present invention. In the following embodiment, the implementation main body of the APP processing method of the present disclosure is alternatively a mobile phone.

The embodiment of the present disclosure provides an APP processing method.

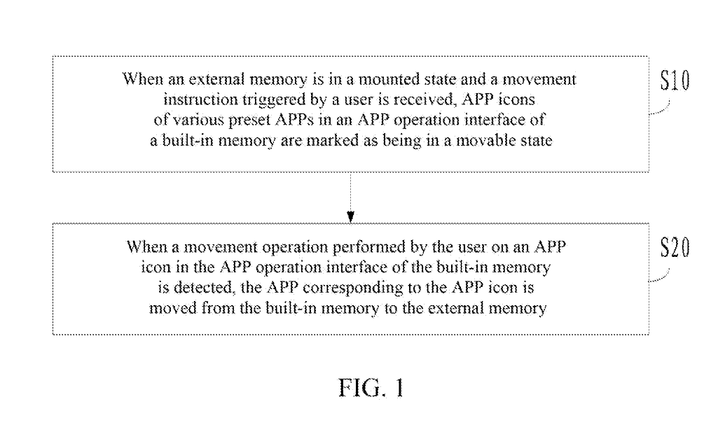

Referring to FIG. 1, FIG. 1 is a flowchart of a first embodiment of an APP processing method according to the present disclosure.

In the first embodiment of the APP processing method of the present disclosure, the method includes the following steps.

Step S10: when an external memory is in a mounted state and a movement instruction triggered by a user is received, APP icons of various preset APPs in an APP operation interface of a built-in memory are marked as being in a movable state.

Herein, the APP operation interface of the built-in memory is set as a default by an operating system in a terminal.

A method for triggering the movement instruction by the user may be preset by the mobile phone, and may be as follows: the movement instruction is triggered in a manner of a gesture, a voice, pressing a touch key, controlling an operation control, text input and the like. The manner for triggering the movement instruction is not limited in the present disclosure.

When receiving the movement instruction triggered by the user, the mobile phone marks the APP icons of various preset APPs in the APP operation interface of the built-in memory as being in the movable state, and the movable state refers to that the user may execute a movement operation on the APP icons.

If various APP icons in the APP operation interface of the built-in memory are not marked as being in the movable state, the user may only implement an operation of adding the APP icon to a desktop, or deleting the APP icon, or unloading the APP corresponding to the APP icon, or acquiring related information of the APP, etc. by pressing the APP icon for long.

Step S20: when a movement operation performed by the user on an APP icon in the APP operation interface of the built-in memory is detected, the APP corresponding to the APP icon is moved from the built-in memory to the external memory.

The user executes the movement operation on the APP icon in the APP operation interface of the built-in memory, herein the movement operation may be dragging the APP icon to a preset position, or clicking the APP icon, or controlling the APP icon for movement operation in a manner of a gesture, a voice, text input and the like. A manner for the movement operation is not limited in the present disclosure.

When detecting the movement operation of the user, the mobile phone moves the APP corresponding to the movement operation from the built-in memory to the external memory, and a manner for movement may be: moving a file and APP icon of the APP to the external memory; or, finding an installation file of the APP from the built-in memory and reinstalling the APP in the external memory. A method for moving the APP to the external memory in the present disclosure is similar to the existing technology, and will not be repeated herein.

In the present embodiment, the user may move the APP to the external memory only by operating the APP icon in the APP operation interface of the built-in memory. Therefore, the operation of the user is facilitated, and APP movement efficiency is improved.

In the present embodiment, a method for moving the APP from the external memory to the built-in memory may also be implemented by the following steps:

when the external memory is in the mounted state and a movement instruction triggered by the user is received, APP icons of various APPs in an APP operation interface of the external memory are marked as being in the movable state; and

when a movement operation performed by the user on an APP icon in the APP operation interface of the external memory is detected, the APP corresponding to the movement operation is moved from the external memory to the built-in memory.

In the present embodiment, the user may also move the APP to the built-in memory by operating the APP icon in the APP operation interface of the external memory.

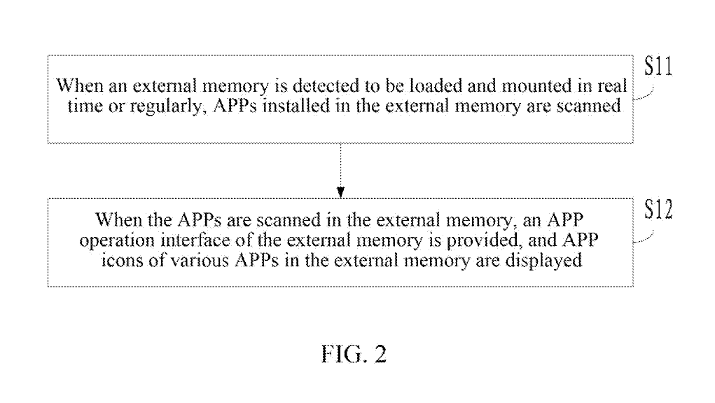

Referring to FIG. 2, FIG. 2 is a flowchart of a second embodiment of an APP processing method according to the present disclosure.

In the second embodiment of the APP processing method of the present disclosure, on the basis of the first embodiment, Step S10 in the present embodiment includes the following steps.

Step S11: when the external memory is detected to be loaded and mounted in real time or regularly, APPs in the external memory are scanned; and

Step S12: when the APPs are scanned in the external memory, an APP operation interface of the external memory is provided, and APP icons of various APPs in the external memory are displayed.

A specific method for detecting whether the external memory is loaded and mounted or not by the mobile phone is similar to the existing technology, and will not be repeated herein.

When the external memory (such as a Secure Digital (SD) Memory Card) is in the mounted state, the mobile phone scans the APPs installed in the external memory, and when the APPs are scanned in the external memory, provides the APP operation interface of the external memory, the APP operation interface of the external memory may be displayed on a Home Screen of the mobile phone, and may also be displayed on a Launcher interface or another slave interface, and the APP operation interface of the built-in memory and the APP operation interface of the external memory are switched to be displayed through the operation control.

In addition, when it is detected by the mobile phone that the external memory is not loaded and mounted, the step is continuously executed for detecting whether the external memory is loaded and mounted or not in real time or regularly.

According to the present embodiment, the mounted state of the external memory is detected in real time. When the external memory is successfully mounted, the APP icons of various APPs installed in the external memory may be rapidly displayed, so that the user may conveniently view the APPs installed in the external memory.

In a third embodiment of the APP processing method of the present disclosure, on the basis of the first embodiment and the second embodiment, before Step S10, the embodiment also includes that:

an edit control is provided for the user to trigger the movement instruction by virtue of the edit control.

According to the embodiment, the user triggers the movement instruction by controlling the edit control, so that the operation of the user is facilitated.

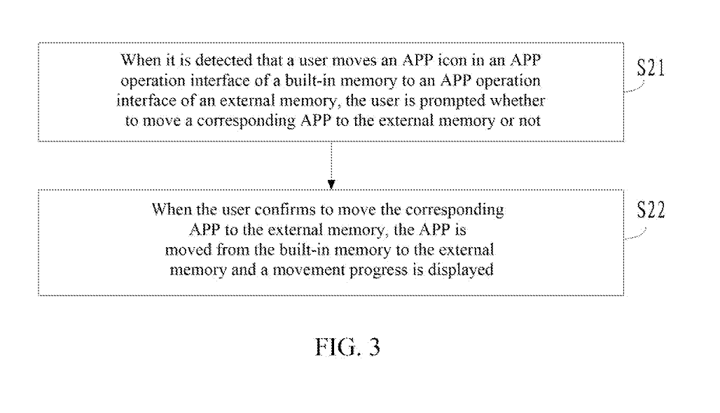

Referring to FIG. 3, FIG. 3 is a flowchart of a fourth embodiment of an APP processing method of the present disclosure.

In the fourth embodiment of the APP processing method of the present disclosure, on the basis of the first embodiment, the second embodiment and the third embodiment, Step S20 in the present embodiment includes the following steps.

Step S21: when it is detected that the user moves the APP icon in the APP operation interface of the built-in memory to the APP operation interface of the external memory, the user is prompted whether to move the corresponding APP to the external memory or not.

Step S22: when the user confirms to move the corresponding APP to the external memory, the APP is moved from the built-in memory to the external memory and a movement progress is displayed.

A manner for moving the APP icon may be a manner of long pressing and dragging manner, or direct dragging or the like. Display of the movement progress may be implemented in a manner of displaying a progress bar.

In some embodiments, the user may also control the APP icon for the movement operation by clicking the APP icon or in a manner of a gesture, a voice, text input and the like. For example, when the user clicks an APP icon twice, the mobile phone prompts the user whether to move the APP corresponding to the APP icon clicked twice to the external memory or not, and if YES, moves the APP to the external memory and a progress bar is displayed.

Of course, in some embodiments, it is unnecessary to display the movement progress, but displaying the movement progress may enable the user to conveniently learn about a current movement progress.

According to the present embodiment, the user may move the APP to the external memory by dragging the APP icon, so that the operation of the user is facilitated. When there are multiple external memories, the user may drag the APP icon to select the memory to which the APP is required to be moved.

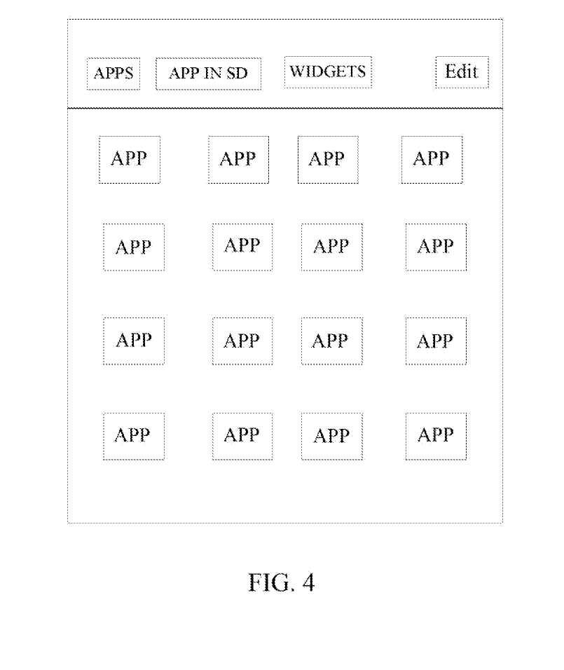

Referring to FIG. 4, FIG. 4 is a schematic diagram of an APP operation interface of an external memory.

An example may be listed below to help understanding.

In FIG. 4, “APPS”, “APP IN SD” and “WIDGETS” are three operation controls, herein “APP” controls display of the APP operation interface of the built-in memory, “APP IN SD” controls display of the APP operation interface of the external memory, “edit” is an edit control, and “APP” is an APP icon. The user triggers a movement instruction when pressing the edit control identified as “edit”.

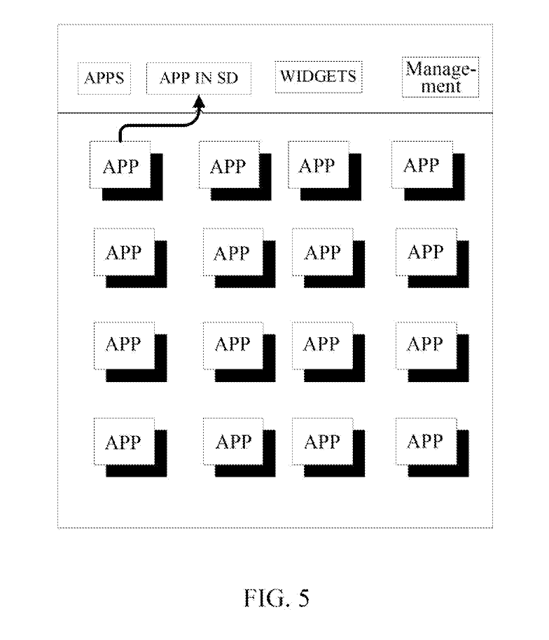

Referring to FIG. 5, FIG. 5 is a schematic diagram of an APP icon marked as being in a movable state. The APP icon identified as “APP” in FIG. 5 is marked as being in the movable state. When the user moves the APP icon to the operation control identified as “APP IN SD”, “APP IN SD” controls display of the APP operation interface of the external memory.

In a fifth embodiment of the APP processing method of the present disclosure, on the basis of the first embodiment, the second embodiment, the third embodiment and the fourth embodiment, after the Step S12, the embodiment includes that:

When it is detected that the external memory is removed, the APP operation interface of the external memory is closed.

When the mobile phone detects that the external memory is removed, the mobile phone hides or removes the APP operation interface of the external memory.

The present disclosure further provides a terminal.

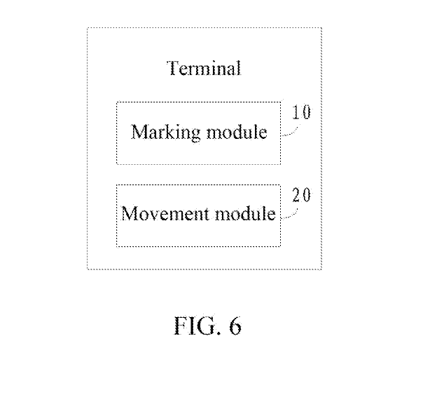

Referring to FIG. 6, FIG. 6 is a schematic diagram of function modules of a first embodiment of a terminal according to the present disclosure.

In the first embodiment of the terminal of the present disclosure, the terminal includes the following modules.

A marking module 10 is arranged to, when an external memory is in a mounted state and a movement instruction triggered by a user is received, mark APP icons of various preset APPs in an APP operation interface of a built-in memory as being in a movable state; and

A movement module 20 is arranged to, when a movement operation performed by the user on an APP icon in the APP operation interface of the built-in memory is detected, move the APP corresponding to the APP icon from the built-in memory to the external memory.

Herein, the APP operation interface of the built-in memory is set as a default by an operating system.

A method for triggering the movement instruction by the user may be preset by the marking module 10, and may be as follows: the movement instruction is triggered in a manner of a gesture, a voice, pressing a touch key, controlling an operation control, text input and the like. The manner for triggering the movement instruction is not limited in the present disclosure.

When receiving the movement instruction triggered by the user, the marking module 10 marks the APP icons of various preset APPs in the APP operation interface of the built-in memory as being in the movable state, and the movable state refers to that the user may execute a movement operation on the APP icons.

If various APP icons in the APP operation interface of the built-in memory are not marked as being in the movable state, the user may only implement an operation of adding the APP icon to a desktop, or deleting the APP icon, or unloading the APP corresponding to the APP icon, or acquiring related information of the APP, etc. by pressing the APP icon for long.

The user executes the movement operation on the APP icon in the APP operation interface of the built-in memory, herein the movement operation may be dragging the APP icon to a preset position, or clicking the APP icon, or controlling the APP icon for movement operation in a manner of a gesture, a voice, text input and the like. A manner for the movement operation is not limited in the present disclosure.

When detecting the movement operation of the user, the movement module 20 moves the APP corresponding to the movement operation from the built-in memory to the external memory, and a manner for movement may be as follows: moving a file and APP icon of the APP to the external memory; or, finding an installation file of the APP from the built-in memory and reinstalling the APP in the external memory. A method for moving the APP to the external memory in the present disclosure is similar to the existing technology, and will not be repeated herein.

In the present embodiment, the user may move the APP to the external memory only by operating the APP icon in the APP operation interface of the built-in memory. Therefore, the operation of the user is facilitated, and APP movement efficiency is improved.

In the present embodiment, a method for moving the APP from the external memory to the built-in memory may be implemented by the following steps.

When the external memory is in the mounted state and a movement instruction triggered by the user is received, APP icons of various APPs in an APP operation interface of the external memory are marked as being in the movable state.

When a movement operation performed by the user on an APP icon in the APP operation interface of the external memory is detected, the APP corresponding to the movement operation is moved from the external memory to the built-in memory.

In the present embodiment, the user may also move the APP to the built-in memory by operating the APP icon in the APP operation interface of the external memory.

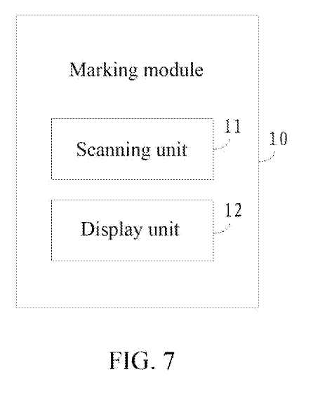

Referring to FIG. 7, FIG. 7 is a schematic diagram of function modules of a second embodiment of a terminal according to the present disclosure.

In the second embodiment of the terminal of the present disclosure, on the basis of the first embodiment, the marking module 10 in the embodiment includes the following units.

A scanning unit 11 is arranged to, when the external memory is detected to be loaded and mounted in real time or regularly, scan APPs in the external memory; and

A display unit 12 is arranged to, when the APPs are scanned in the external memory, provide an APP operation interface of the external memory, and display APP icons of various APPs in the external memory.

A specific method for detecting whether the external memory is loaded and mounted or not by the scanning unit 11 is similar to the existing technology, and will not be repeated herein.

When the external memory (such as a SD Memory Card(Security Digital Card)) is in the mounted state, the scanning unit 11 scans the APPs installed in the external memory, and when the APPs are scanned in the external memory, the display unit 12 provides the APP operation interface of the external memory, the APP operation interface of the external memory may be displayed on a Home Screen of the mobile phone, and may also be displayed on a Launcher interface or another slave interface, and the APP operation interface of the built-in memory and the APP operation interface of the external memory are switched to be displayed through the operation control.

In addition, when it is detected by the scanning unit 11 that the external memory is not loaded and mounted, the step is continuously executed for detecting whether the external memory is loaded and mounted or not in real time or regularly.

According to the present embodiment, the mounted state of the external memory is detected in real time, and when the external memory is successfully mounted, the APP icons of various APPs installed in the external memory may be rapidly displayed, so that the user may conveniently view the APPs installed in the external memory.

In a third embodiment of the terminal of the present disclosure, on the basis of the first embodiment and the second embodiment, the terminal in the embodiment also includes:

provision of an edit control (which is not shown in the figure) for the user to trigger the movement instruction by virtue of the edit control.

According to the present embodiment, the user triggers the movement instruction by controlling the edit control, so that the operation of the user is facilitated.

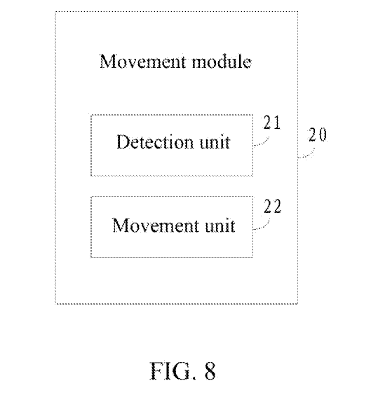

Referring to FIG. 8, FIG. 8 is a schematic diagram of function modules of a fourth embodiment of a terminal according to the present disclosure.

In the fourth embodiment of the APP processing method of the present disclosure, on the basis of the first embodiment, the second embodiment and the third embodiment, the movement module 20 in the embodiment includes the following units.

A detection unit 21 is arranged to, when it is detected that the user moves the APP icon in the APP operation interface of the built-in memory to the APP operation interface of the external memory, prompt the user whether to move the corresponding APP to the external memory or not.

A movement unit 22 is arranged to, when the user confirms to move the corresponding APP to the external memory, move the APP from the built-in memory to the external memory and display a movement progress.

A manner for moving the APP icon may be a manner of long pressing and dragging manner, or direct dragging or the like. Display of the movement progress may be implemented in a manner of displaying a progress bar.

In some embodiments, the user may also control the APP icon for the movement operation by clicking the APP icon or in a manner of a gesture, a voice, text input and the like. For example, when the user clicks an APP icon twice, the mobile phone prompts the user whether to move the APP corresponding to the APP icon clicked twice to the external memory or not, and if YES, moves the APP to the external memory and a progress bar is displayed.

Of course, in some embodiments, it may be unnecessary to display the movement progress, but displaying the movement progress may enable the user to conveniently learn about a current movement progress.

According to the present embodiment, the user may move the APP to the external memory by dragging the APP icon, so that the operation of the user is facilitated. Besides, when there is a plurality of external memories, the user may drag the APP icon to select the memory to which the APP is required to be moved.

In a fifth embodiment of the terminal of the present disclosure, on the basis of the first embodiment, the second embodiment, the third embodiment and the fourth embodiment, the terminal in the embodiment includes that the following steps.

When it is detected that the external memory is removed, close the APP operation interface of the external memory.

When it is detected that the external memory is removed, the mobile phone may hide or remove the APP operation interface of the external memory.

The above is only the alternative embodiment of the present disclosure and not thus intended to limit the scope of patent of the present disclosure. Any equivalent structure or equivalent flow transformation made by virtue of contents of the specification and drawings of the present disclosure or direct or indirect application of the contents to other related technical fields shall fall within the scope of protection of the patent of the present disclosure.

### INDUSTRIAL APPLICABILITY

According to the embodiment of the present disclosure, the user may move the APP to the external memory only by operating the APP icon in the APP operation interface of the built-in memory. Therefore, the embodiment of the present disclosure brings convenience to the operation of the user and improves the efficiency of moving APP movement.

1. An Application, APP, processing method, the APP processing method comprising following steps:
when an external memory is in a mounted state and a movement instruction triggered by a user is received, marking APP icons of various preset APPs in an APP operation interface of a built-in memory as being in a movable state; and
when a movement operation performed by the user on an APP icon in the APP operation interface of the built-in memory is detected, moving an APP corresponding to the APP icon from the built-in memory to the external memory.

2. The APP processing method according to claim 1, wherein the step of when the external memory is in the mounted state comprises:
when the external memory is detected to be loaded and mounted in real time or regularly, scanning APPs in the external memory; and
when the APPs are scanned in the external memory, providing an APP operation interface of the external memory, and displaying APP icons of various APPs in the external memory.

3. The APP processing method according to claim 2, wherein the step of moving the APP corresponding to the movement operation from the built-in memory to the external memory when the movement operation performed by the user on the APP icon in the APP operation interface of the built-in memory is detected comprises:
when it is detected that the user moves the APP icon in the APP operation interface of the built-in memory to the APP operation interface of the external memory, prompting the user whether to move a corresponding APP to the external memory or not; and
when the user confirms to move the corresponding APP to the external memory, moving the APP from the built-in memory to the external memory and displaying a movement progress.

4. The APP processing method according to claim 1, wherein before the step of marking the APP icons of various preset APPs in the APP operation interface of the built-memory as being in the movable state when the movement instruction triggered by the user is received, the APP processing method comprising:
providing an edit control for the user to trigger the movement instruction.

5. The APP processing method according to claim 2, wherein after the step of providing the APP operation interface of the external memory and displaying the APP icons of various APPs in the external memory, comprising:
when it is detected that the external memory is removed, closing the APP operation interface of the external memory.

6. A terminal comprising:
a marking module arranged to, when an external memory is in a mounted state and a movement instruction triggered by a user is received, mark Application, APP, icons of various preset APPs in an APP operation interface of a built-in memory as being in a movable state; and
a movement module arranged to, when a movement operation performed by the user on an APP icon in the APP operation interface of the built-in memory is detected, move an APP corresponding to the APP icon from the built-in memory to the external memory.

7. The terminal according to claim 6, wherein the marking module comprises:
a scanning unit arranged to, when the external memory is detected to be loaded and mounted in real time or regularly, scan APPs in the external memory; and
a display unit, arranged to, when APPs are scanned in the external memory, provide an APP operation interface of the external memory, and display the APP icons of various APPs in the external memory.

8. The terminal according to claim 7, wherein the movement module comprises:
a detection unit arranged to, when it is detected that the user moves the APP icon in the APP operation interface of the built-in memory to the APP operation interface of the external memory, prompt the user whether to move a corresponding APP to the external memory or not; and
a movement unit, arranged to, when the user confirms to move the corresponding APP to the external memory, move the APP from the built-in memory to the external memory and display a movement progress.

9. The terminal according to claim 6, wherein the terminal comprises:
an edit control provision module, arranged to provide an edit control for the user to trigger the movement instruction.

10. The terminal according to claim 6, wherein the display unit is further arranged to,
when it is detected that the external memory is removed, close the APP operation interface of the external memory.

11. The APP processing method according to claim 2, wherein before the step of marking the APP icons of various preset APPs in the APP operation interface of the built-memory as being in the movable state when the movement instruction triggered by the user is received, the APP processing method comprising:
providing an edit control for the user to trigger the movement instruction.

12. The APP processing method according to claim 3, wherein before the step of marking the APP icons of various preset APPs in the APP operation interface of the built-memory as being in the movable state when the movement instruction triggered by the user is received, the APP processing method comprising:
providing an edit control for the user to trigger the movement instruction.

13. The APP processing method according to claim 3, wherein after the step of providing the APP operation interface of the external memory and displaying the APP icons of various APPs in the external memory, comprising:
when it is detected that the external memory is removed, closing the APP operation interface of the external memory.

14. The terminal according to claim 7, wherein the terminal comprises:
an edit control provision module, arranged to provide an edit control for the user to trigger the movement instruction.

15. The terminal according to claim 8, wherein the terminal comprises:
an edit control provision module, arranged to provide an edit control for the user to trigger the movement instruction.

16. The terminal according to claim 7, wherein the display unit is further arranged to,
when it is detected that the external memory is removed, close the APP operation interface of the external memory.
